(19) United States
(12) Patent Application Publication
(10) Pub. No.: US 2005/0213220 A1
(43) Pub. Date: Sep. 29, 2005

(54) Viewing device

(76) Inventor: Paul Meyer, Cambridgeshire (GB)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/509,720

(22) PCT Filed: Apr. 1, 2003
(86) PCT No.: PCT/GB03/01420

§ 371 Date: May 9, 2005

(30) Foreign Application Priority Data
Apr. 2, 2002 (GB) 0207630.5

(51) Int. Cl. G02B 3/00

(52) U.S. Cl. 359/642

(57) ABSTRACT

A viewing device comprises a pair of substantially inflexible nesting lenses. One of the lenses has a divergent refracting surface and the other has a convergent refracting surface. The device further comprises means for moving at least one of the lenses in a direction substantially normal to the refracting surfaces so as to create a cleft of changing width between facing surfaces of the lenses.

This invention relates to viewing devices and is particularly directed to viewing devices capable of accommodation to allow focused viewing of objects at varying distances from the user of the device.

Although the human eye has some capacity for accommodation when viewing objects at varying distances from the eye, such accommodation becomes less effective with age. Various adaptations of spectacles are in use to address this problem, for example bifocal, multifocal or “varifocal” lenses. These approaches achieve clear focus only at particular viewing distances (usually at the near point and at infinity) and restrict the field of focused vision at each of them. Furthermore, they require the user to alter the elevation of his eyes in order to select a focal plane.

In an early attempt (Wright B. M., “Variable Focus Spectacles”: Trans. Ophthal. Soc. U.K. (1978) 98, 84-87) to produce adjustable focus lenses, oil was forced into a chamber between fixed and flexible glass plates. Distortion of the flexible plate altered the focusing power. Other distorting lenses have been introduced since.

Spectacles that replace or complement the accommodative power of the failing lens are in contrast to telescope spectacles based on the Galilean telescope, which magnify near or distance vision. In these, a convex lens is placed before a concave lens of shorter focal length, their separation being close to the difference between their focal lengths (see “System of Ophthalmology—Vol. V: Ophthalmic Optics and Refraction”, pp 804-805, ed. Sir Stewart Duke-Elder: Mosby 1970; and U.S. Pat. No. 5,076,682)

Since the natural deterioration of accommodation occurs in middle age, it interferes with every aspect of domestic, recreational and professional life to which a subject has become accustomed. For example, the preparation of a meal, reading music on a stand, undertaking machine work or viewing plans, all require an ability to focus any plane from nearby to infinity. A device that truly replicated visual accommodation would also enhance the quality of life among those individuals who lose accommodation in their youth for medical reasons.

Accordingly, in a first aspect the present invention provides a viewing device comprising:
a pair of nesting lenses, one of the lenses having a divergent refracting surface and the other having a convergent refracting surface; and
means for moving at least one of the lenses in a direction substantially normal to the refracting surfaces so as to create a cleft of changing width between facing surfaces of the lenses. Preferably the lenses are substantially inflexible.

With such a device it is possible to make continuous adjustments to the width of the cleft so that, e.g. to correct presbyopia, an object at any distance can be viewed in any comfortable plane from the presbyopic near point to infinity.

The width of the cleft is typically less than the focal length of the refracting surface of the first of the lenses through which viewed light travels. Preferably it is less than one half or one quarter of this focal length.

Preferably one of the lenses has a concave surface within which nests a convex surface of the other lens, the cleft being created between these surfaces. Typically the lenses are arranged so that viewed light travels through the concave and convex surfaces in that order. Indeed, a further independent aspect of the invention provides a viewing device comprising a first lens having a concave surface within which nests a second lens having a convex surface, and means for moving at least one of the lenses in a direction substantially normal to the facing concave and convex surfaces so as to create a cleft therebetween of changing width.

Embodiments of the device described above base on the finding that, if a cleft is defined by nesting concave and convex lenses, rays are diverged at the concave surface of the first lens, when the medium within the cleft is of refractive index less than that of the lens (e.g. air). The width of the cleft determines the angle of incidence at which the rays strike the facing surface of the second lens. This angle of incidence, and hence the amount of convergence produced by the second lens, increases as the separation of the lenses increases. Thus the separation of the lenses determines the angle at which the rays exit the second lens and the position of the virtual image of the object plane. With increasing separation, the virtual image is displaced further away from the user. Effectively, the cleft itself functions like a “thick lens” with surfaces of equal or different radii of curvature (see Jenkins F. A. and White H. E., “Fundamentals of Optics”, Fourth edition, p. 88, McGraw-Hill 1981). However, unlike such a thick lens, the cleft provides variable focusing due to its changeable width.

An equivalent effect may be achieved in further embodiments in which the lenses have radially varying refractive index gradients. Thus, where the medium in the cleft is air, the first lens may have a relatively low refractive index at the centre, increasing to a high refractive index at the periphery, to provide a divergent refracting surface. Whereas the second lens may have a relatively high refractive index at the centre, decreasing to a low refractive index at the periphery, to provide a convergent refracting surface. Such lenses can be of substantially uniform thickness, i.e. they can be plates. Thus, in relation to the present invention, by the term “lens” we mean any optical body which produces the respective refracting surface.

In one form of the invention, the material of the lenses and the medium within the cleft are selected so that the facing (preferably concave and convex) surfaces each provide refracting surfaces.

However, in a further form of the invention, the lenses have the form of curved (preferably spherical) light-transmitting plates separated by an oil or other fluid of high refractive index within the cleft. By “high refractive index” we preferably mean a refractive index greater than that of the medium (typically air) surrounding the device. The oil or other fluid may be of refractive index substantially the same as that of the plates, in which case the refracting surfaces are the outer lens surfaces. If the plates are relatively thin compared to the width of the cleft, the focusing power of the device will be due almost entirely to the oil or other fluid within the cleft (which again effectively functions like a “thick lens”). Furthermore, if the cleft is defined by nesting first and second plates respectively having concave and convex facing surfaces, rays are converged at the first plate and diverged at the second plate, which is in contrast to embodiments with air-filled clefts described previously.

Thus it will be appreciated that the medium within the cleft may be of refractive index similar to or greater than that of the lenses, for example a fluid of high refractive index such as silicone oil.

Preferably the facing surfaces have complementary shapes so that when they are brought into precise juxtaposition, the cleft between them is virtually eliminated. For example, if the facing surfaces are respectively spherical convex and spherical concave, and have the same radius of curvature, they may be brought into juxtaposition in this way. As the lenses are moved apart along their shared axis, the cleft between them is of changing width but uniform thickness for any one spaced separation.

Both of the outer lens surfaces may conveniently be substantially planar. However it is anticipated that one or both of the outer lens surfaces may be contoured to deal with particular refractive errors of the user. The lenses may be constructed of any suitable light transmitting material including high refractive index plastics or glass. Their refractive indices may be the same or different. The lens surfaces may be coated to enhance transmission, or tinted, as is well known in the optical field. Each lens may comprise more than one refractive element.

In order to reduce aberrations, or lessen travel of the lenses, more than two lenses may be employed. They may have different refractive indices and define multiple clefts, which clefts may have widths changing at substantially the same or different rates.

The means for moving the lens or lenses may be provided in any suitable way, for example by mounting the lenses in nesting or concentric cylindrical frames which slide or screw in relation to each other. If the cleft is filled with a fluid other than air, e.g. silicone oil, it will be necessary to provide leakproof sealing means to prevent egress of the fluid.

The orientation of the lenses in relation to the user may depend on the medium within the cleft. However, if this medium is air, the device will, in use, generally be positioned so that a lens having a concave surface facing the cleft is closer to the object being viewed.

In certain optical systems (e.g. for creating and moving real images) mirrors may be used for one or both of the spherical surfaces.

In one preferred form of the invention, the device comprises two pairs of first and second lenses intended to be worn as spectacles.

Therefore, a further aspect of the invention provides a pair of spectacles comprising for each eye a viewing device as defined above. Preferably the moving means have a single actuating mechanism common for the pair of spectacles. This actuating mechanism may be mounted on the bridge or arms of the spectacles and may, for example, have the form of a roller, cam, slide or motor. Alternatively, autofocus mechanisms may be incorporated in the spectacles in accordance with known technology.

For spectacle wearers with normal vision but simply a problem of accommodation, it may be satisfactory for the outer surfaces of the lenses to be substantially planar, especially in the situation where the medium within the cleft is of refractive index less than that of the lenses. However, those surfaces may be contoured to facilitate manufacture, for cosmetic purposes or to correct various visual defects as in conventional optical practice. When high refractive index oil is used as the medium within the cleft, the lenses may have curved outer surfaces or they may be replaced by spherical plates.

In embodiments with concave and convex refracting surfaces, the lenses may be arranged so that, in use, the centres of curvature of the refracting surfaces lie close to the axis of rotation of the eye globe of the user. This helps to reduce optical distortions experienced by the user.

In the normal human subject, the optical pathways of the two eyes angle inwards (converge) during accommodation to intersect in the object that is viewed. Spectacles that lessen the need for accommodation may advantageously replicate convergence by e.g. mounting the lens pairs closer together than the inter-pupillary distance, moving the elements of the lens pairs furthest from the user away from each other during accommodation, or directing the axes of the two entire lens assemblies towards the viewed object.

While the lenses will normally be positioned to give a cleft of constant thickness, one of the refracting surfaces may be tilted with respect to the other. Furthermore the pair may be tilted with respect to the optical axis of the user. Their rotation to a selected azimuthal position may, for example, be used for the correction of astigmatism.

Similarly, by optimising the width of the cleft, the tilt of its surfaces with respect to each other and the tilt and azimuthal position of the system with respect to a subject's optical axis, a spherical, as well as an astigmatic correction, can be computed.

The greater the change in refractive index at the main refracting surfaces, the more effective the system i.e. the same displacement of the image can be achieved with smaller separation of the surfaces. Thus the use of high refractive index materials, on either side of or within the cleft, may extend the usefulness of the invention.

Preferably the refracting surfaces are of substantially equal and opposite focusing power. However, by configuring the lenses so that the refracting surface of the divergent lens has a shorter focal length than the refracting surface of the convergent lens, a minifying effect can be achieved. Conversely by configuring the lenses so that the refracting surface of the convergent lens has a shorter focal length than the refracting surface of the divergent lens, a magnifying effect can be achieved.

Thus, in an example with an air-filled cleft, if the internal refracting surfaces are spherical, but have unequal radii of curvature or refractive index, magnification (by means of a convex lens of shorter focal length or higher refractive index) or minification (by means of a convex lens of longer focal length or lower refractive index) is introduced into the variable focal length system. It has been found that, as long as both the internal refracting surfaces are spherical (regardless of their focal lengths), the system introduces little spherical aberration, giving images of high resolution.

The radii of curvature of the external surfaces affect the image in a manner which is predictable by conventional optics. Therefore the system can be computed using nested meniscus lenses. If the external surfaces are appropriately curved, additional refractive effects may be incorporated in the device, e.g. for correction of myopia or hypermetropia with or without astigmatism.

In a special case of this principle, a positive contact lens is used as the second refractive element in the system. In front of this is placed a negative lens (meniscus or plano-concave) of short back focal length, with its concave surface facing the convexity of the cornea. Variable focus is achieved by moving this lens towards or away from the eye.

If two internal refracting surfaces are aspheric, either matched or unmatched, the system can introduce predictable aberrations (e.g. a fish eye effect for photography or displays).

If the weight or thickness of the lenses is too great for the desired application, it is contemplated that the lenses may be replaced by “spherical” Fresnel lenses formed of engraved concentric prisms.

The invention will now be described by way of example with reference to the accompanying drawings, wherein:

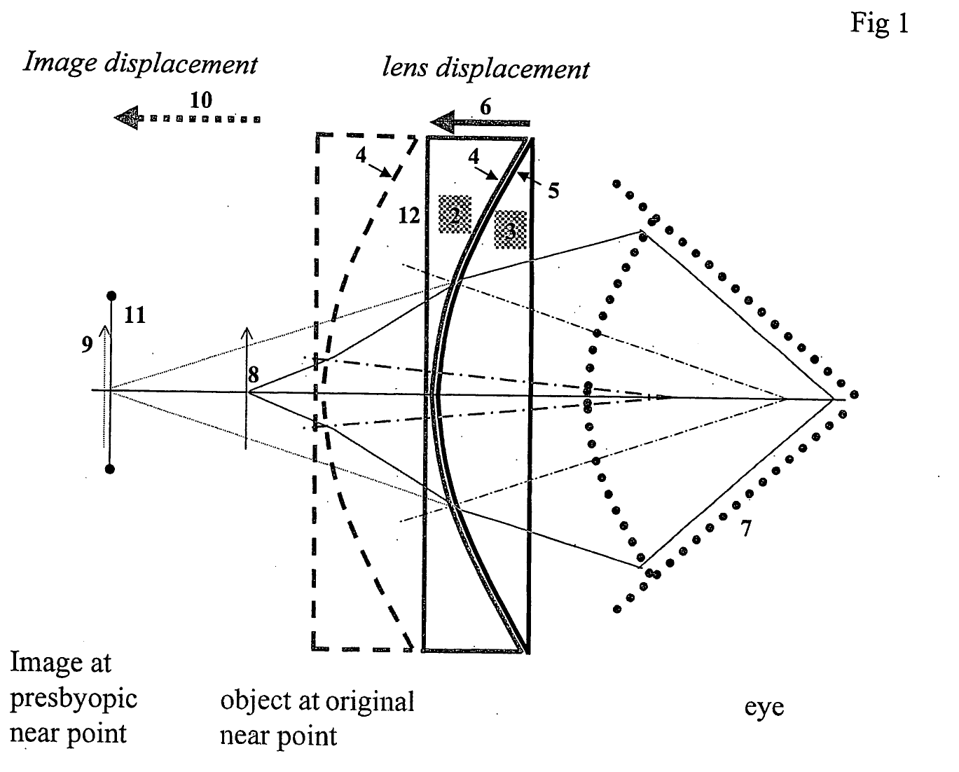

FIG. 1 is a diagrammatic representation illustrating the principle of the invention;

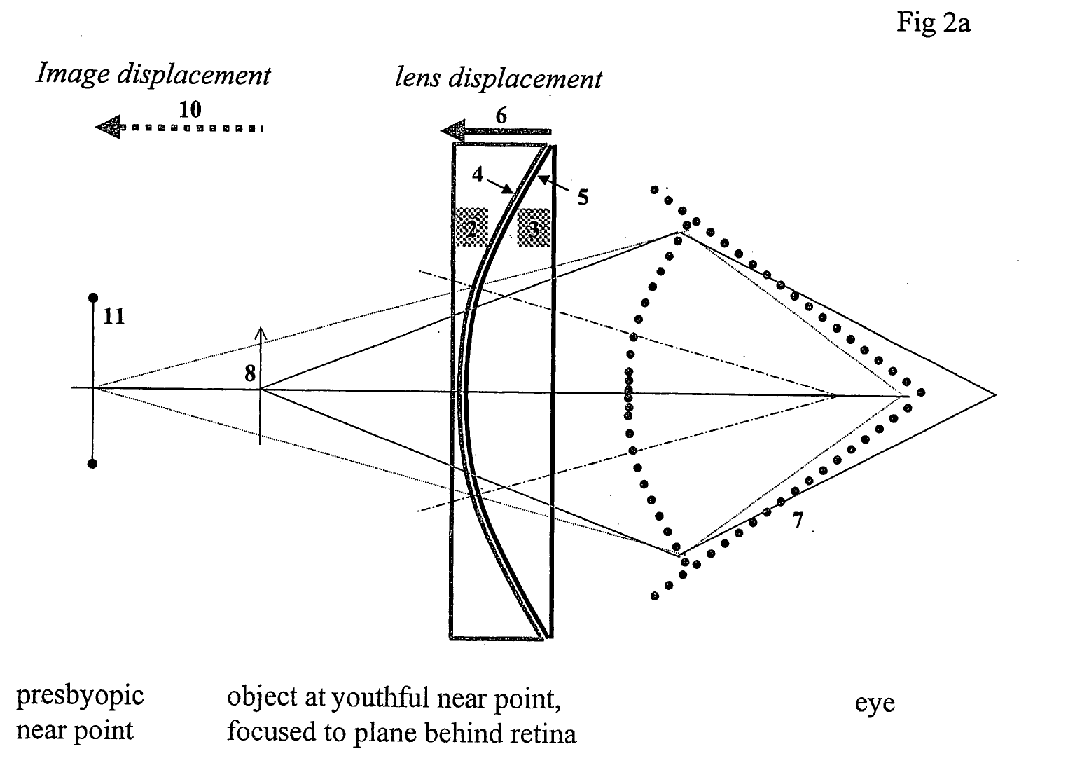

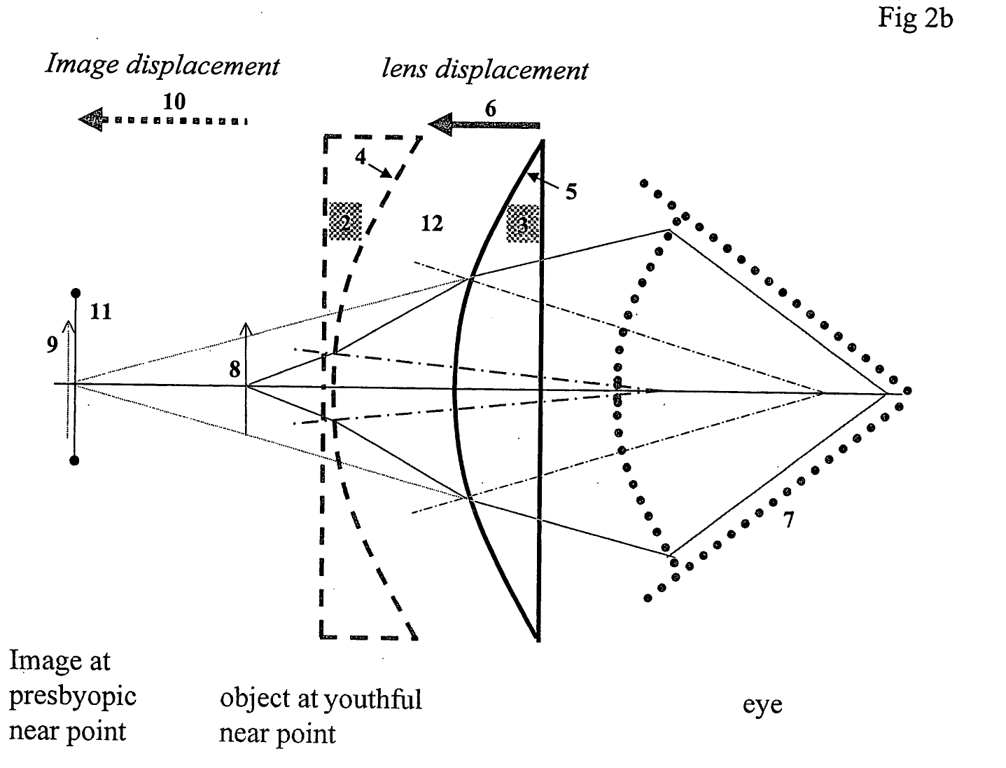

FIGS. 2a and 2b are diagrams illustrating how an object can be brought into focus by separation of the lenses of the viewing device;

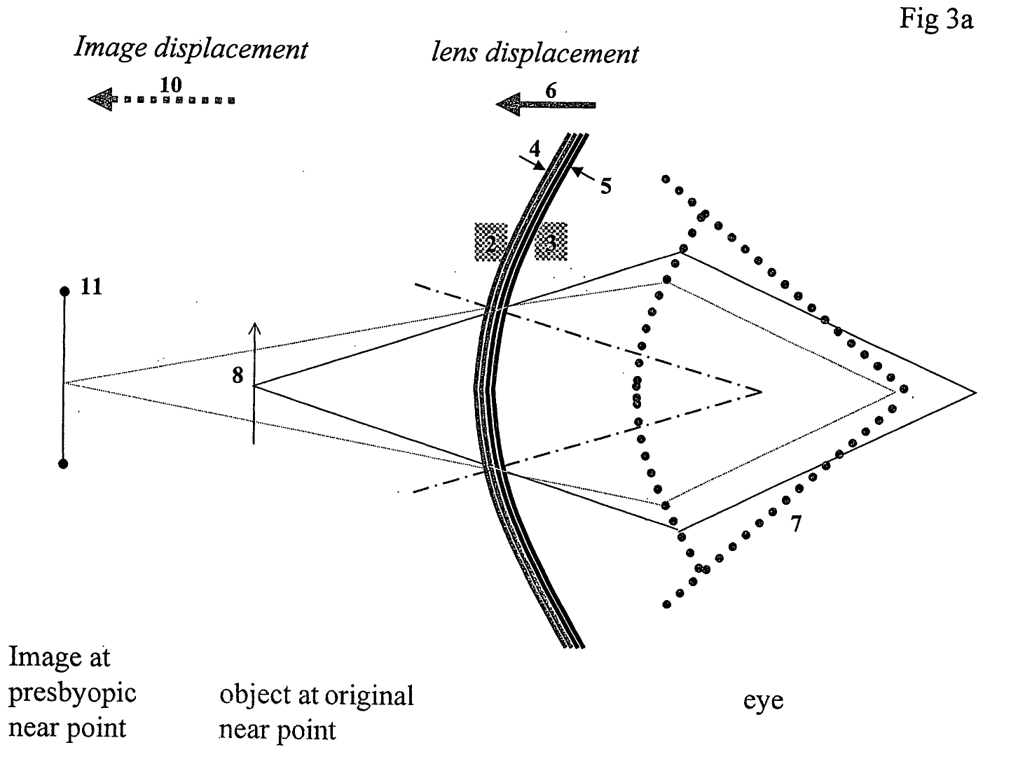

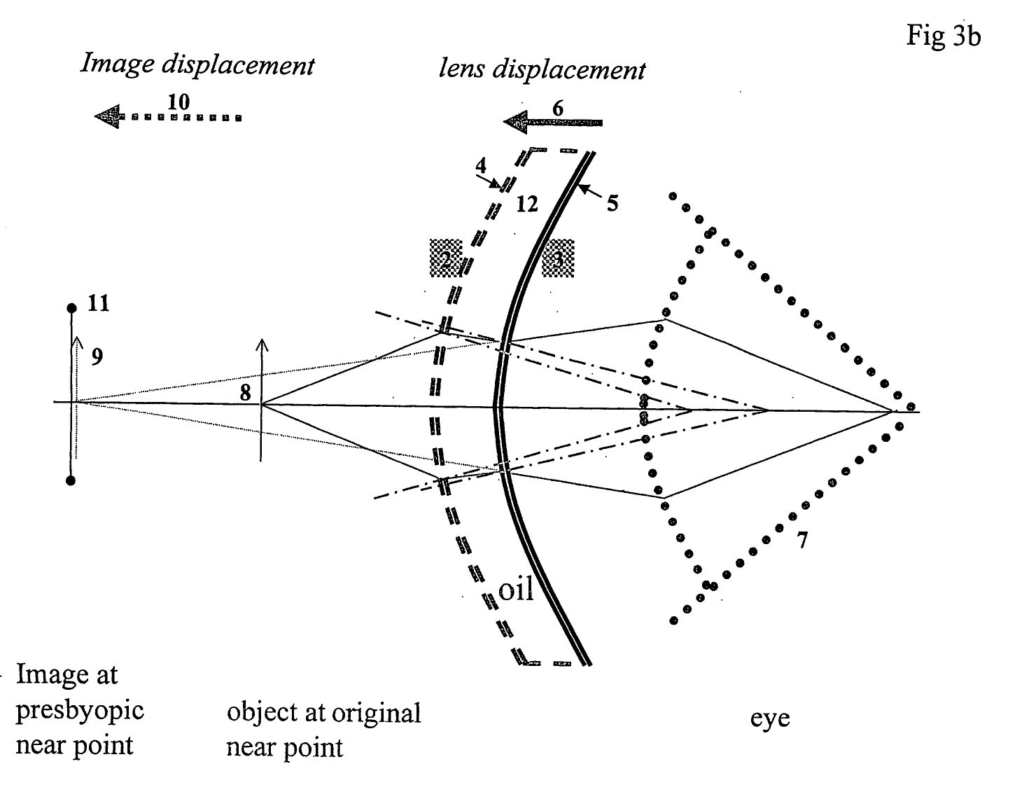

FIGS. 3a and 3b are diagrams illustrating how an object can be brought into focus by separation of the lenses of an alternative form of the viewing device; and

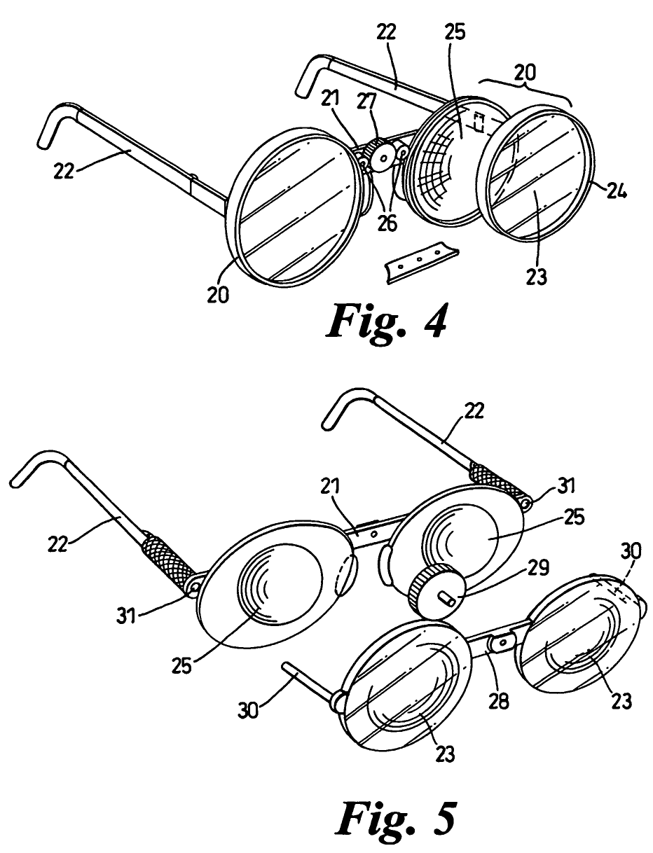

FIGS. 4 and 5 are sketches, each showing a pair of spectacles in accordance with the invention.

FIG. 1 shows a device having a first plano-concave lens 2 and a second plano-convex lens 3, the concave surface 4 of lens 2 and the convex surface 5 of lens 3 being initially snugly nested together as shown in full lines. The surfaces 4 and 5 are substantially spherical and have the same radius of curvature, and thus have equal and opposite focusing powers. When snugly nested as shown in full lines, there is effectively no cleft between the lenses and the pair behaves as a single planar lens.

Means (not shown) are provided for displacement of lens 2 in a direction shown by arrow 6 to a position shown in dashed lines, or to any intermediate position between the dashed and full line positions. This defines a cleft 12 of changeable width but uniform thickness between the surfaces 4 and 5. The medium within the cleft is typically air.

The lenses 2 and 3 are positioned in front of an eye, shown schematically by dotted lines 7. An object 8 is shown placed in front of lens 2. If the lens 2 is in the position shown in dashed lines, the rays from the object 8 will be refracted to diverge at surface 4 and will be again refracted to converge as they pass through surface 5, the extent of convergence depending on the angle of incidence, which becomes greater as the separation 6 of the surfaces increases and the second surface is intersected further from the optical axis. The image 9 of the object 8 will thus be seen at a plane which has been displaced in the direction of line 10 from the object 8. Dependent on the extent of the lens displacement indicated by arrow 6, this will bring the image 9 to a plane at or close to the near point focal plane 11 of the eye.

FIG. 2a shows a viewing device where the lenses 2 and 3 are in the position equivalent to that shown in full lines in FIG. 1. The ray diagram is shown for the viewing of a comparatively close object 8 by a presbyopic user who has a near point focal plane 11. Although the object is in a position suitably accommodated by a normal “youthful” eye, it is closer to the user's eye than the near point focal plane 11 of the eye, i.e. the presbyopic near point of that user. The object 8 will therefore be focused to a plane behind the retina of the eye and cannot be brought correctly into focus by the user.

FIG. 2b shows the device where the lens 2 has been moved in direction 6 to a position shown in dashed lines. The refraction at facing internal surfaces 4 and 5 is now sufficient to move the focus of object 8 to a plane coincident with the retina of the eye. The image 9 is thus at or near the near point focal plane 11 for that user and the object is in focus for that user. Internal surface 4 forms a divergent refracting surface and internal surface 5 forms a convergent refracting surface.

FIGS. 3a and b show an alternative form of the viewing device. The same numbering is used as for FIG. 1 and FIGS. 2a and b. However, in this alternative form, lenses 2 and 3 are spherical transparent plates of uniform thickness rather than plano-concave and plano-convex lenses. In FIG. 3a the transparent plates 2 and 3 are in close apposition, and in FIG. 3b the plate 2 has been moved in direction 6 to a position shown in dashed lines. Thus FIGS. 3a and b correspond to FIGS. 2a and b.

In FIG. 3a, like FIG. 2a, the object 8 is focused to a plane behind the retina of the eye and cannot be brought correctly into focus by the user.

However, in FIG. 3b the intervening cleft 12 is filled with oil, preferably of similar refractive index to the plates. Thus the refracting surfaces 4 and 5 are both formed by the outer surfaces of the plates and the plate-oil interfaces. As the width of the cleft increases, incident rays strike the first refracting surface further from the optical axis (therefore with a higher angle of incidence) than the second surface. Convergence exceeds divergence and refraction at these surfaces is sufficient to move the focus of object 8 to a plane coincident with the retina of the eye, so that the image 9 is seen at or near the near point focal plane 11 for that user and the object is in focus for that user. Although the curvatures of the surfaces are identical to those in FIG. 2b, refracting surface 4 is here convergent and refracting surface 5 is divergent.

FIGS. 4 and 5 each show a pair of spectacles in accordance with the invention. Each pair of spectacles comprises two viewing devices 20 linked by a nose bridge 21 and provided for wearing purposes with side arms 22. Each viewing device 20 has a first plano-concave lens and a second plano-convex lens as described below.

FIG. 4 shows one of the viewing devices 20 in exploded form. This has a first plano-concave lens 23 which has an internally threaded sleeved mount 24. The sleeve of this mount 24 threads over the threaded frame of a second plano-convex lens 25, so as to permit lens 23 to move towards and away from lens 25 to alter the spacing therebetween.

It will be appreciated that, in the absence of further actuating means, each lens 23 can be separately hand adjusted with respect to its associated lens 25. However, as shown in FIG. 4, common actuating means are provided. Thus, each lens mount 24 meshes with a gear wheel 26 and the two gearwheels share a common actuating roller 27 mounted on bridge 21, whereby the wearer can adjust the spacing of the two lenses simultaneously.

FIG. 5 shows an alternative form of actuating means. The pair of plano-concave lenses 23 are joined by a second bridge 28. Bridges 21 and 28 are linked by a roller mechanism shown schematically at 29. Each lens 23 carries at its outer side a slide 30, intended to engage a sleeve 31 within the side arm of the frame holding the convex lenses 25. Operation of roller 29 by the wearer allows movement of the lenses 23 towards or away from the lenses 25.

Other spectacles may have the actuating means located on one of the side arms. This avoids the problem of the user obscuring his own vision when operating the actuating means to adjust the spacing of the lenses.

It will be seen from the above description that the device in accordance with the invention can find a wide variety of applications. These are contemplated as including:
variable focus spectacles (including autofocus spectacles) and eye-glasses;
existing spectacles can be made to have variable focus by clipping a pair of matched divergent and convergent (e.g. concave and convex) lenses to their inner or outer surfaces;
spectacles for correction of aphakia, without the need for refraction and incorporating variable focus (this can be of value in less developed countries where the cost of implanting intraocular lenses is potentially prohibitive);
variable focus contact lenses;
intraocular lens implants with variable focus, to replace the natural lens after cataract extraction;
provision of substantially aberration-free minifying spectacles with variable focus (e.g. by configuring the lenses so that the refracting surface of the divergent lens has a higher absolute power than the refracting surface of the convergent lens), allowing the titration of visual field against visual acuity (e.g. presenting a large field of vision onto a diminished area of innervated retina in a patient with glaucoma);
provision of substantially aberration-free magnifying spectacles with variable focus (e.g. by configuring the lenses so that the refracting surface of the convergent lens has a higher absolute power than the refracting surface of the divergent lens) in order to present an enlarged image of a reduced field of vision to diseased central retina;
correction of astigmatism using paired spherical lenses with axes tilted with respect to the user's optical axis;
provision of objectives or eyepieces for optical instruments such as binoculars, telescopes, cameras, theodolites, microscopes and range finders;
creating windows over displays (e.g. in cars or aircraft; instruments in laboratories or workshops; virtual reality displays) with the ability to move the image to a plane more suitable for viewing;
camera lenses, especially variable focus macro lenses and zoom lenses.

The contemplated use can also be extended to:
projection systems;
illumination systems;
imaging systems.

Where appropriate in any of the above applications, one or both of the refractive elements may be mirrors. Additionally or alternatively, the device may be supplemented by further convergent or divergent lenses.

1-14. (canceled)

15. An eyesight correction device, comprising:
a pair of substantially inflexible nesting lenses, one of the lenses having a divergent refracting surface and the other having a convergent refracting surface; and
means for moving at least one of the lenses in a direction substantially normal to the refracting surfaces so as to create a cleft of changing width between facing surface of the lenses;
wherein the lenses are arranged so that viewed light travels through the divergent refracting surface and convergent refracting surface in that order.

16. An eyesight correction devices according to claim 15, wherein the width of the cleft is less than the focal length of the refracting surface of the first of the lenses through which viewed light travels.

17. An eyesight correction device according to claim 15, wherein one of the lenses has a concave surface within which nests a convex surface of the other of the lenses, the cleft being created between said surfaces.

18. An eyesight correction device according to claim 17, wherein the lenses are arranged so that viewed light travels through the concave and convex surfaces in that order.

19. An eyesight correction device according to claim 15, wherein the facing surfaces of the first and second lenses have complementary shapes so that when they are brought into precise juxtaposition, the cleft between them is virtually eliminated.

20. An eyesight correction device according to claim 15, wherein the refracting surfaces are of substantially equal and opposite focusing power.

21. An eyesight correction device according to claim 15, wherein both of the outer lens surfaces are substantially planar.

22. An eyesight correction device according to claim 15, wherein one or both of the outer lens surfaces are contoured.

23. A pair of spectacles comprising for each eye an eyesight correction device according to claim 15.

24. A pair of spectacles according to claim 23, wherein the moving means have a single actuating mechanism common for the pair of spectacles.

25. A variable focus contact lens comprising an eyesight correction device according to claim 15.

26. A variable focus intraocular lens comprising an eyesight correction device according to claim 15.

27. An optical instrument objective fitted with a variable focusing device, the device comprising:
a pair of substantially inflexible nesting lenses, one of the lenses having a divergent refracting surface and the other having a convergent refracting surface; and
means for moving at least one of the lenses in a direction substantially normal to the refracting surfaces so as to create a cleft of changing width between facing surfaces of the lenses;
wherein the lenses are arranged so that viewed light travels through the divergent refracting surface and convergent refracting surface in that order.
